(19) United States
(12) Patent Application Publication
(10) Pub. No.: US 2005/0221249 A1
(43) Pub. Date: Oct. 6, 2005

(54) Maxillary molar distalization jig

(76) Inventor: Ahmet Ozlem Keles, Berlin, MA (US)

Correspondence Address: John S. Egbert;Harrison & Egbert, 412 Main Street, 7th Floor, Houston, TX, 77002, US

(21) Appl. No.: 10/816,714

(22) Filed: Apr. 5, 2004

(51) Int. Cl. A61C 3/00

(52) U.S. Cl. 433/18

(57) ABSTRACT

An orthodontic appliance for use in a mouth of a user has an acrylic support plate with a wide Nance button and an anterior bite plane, a plurality of retaining wires, a plurality of rigid wire rods, a lock, a coil spring, a tubular member and first molar bands. The acrylic support plate has the retaining wires extending therefrom and is made of acrylic material constructed during installation of the support plate. The first premolar teeth are fixedly attached to the retaining wires chair side. The first molar bands are removably attached to each wire extension of respective tubular member. When the coil spring is compressed between the acrylic support plate and the tubular member by tightening the lock, the tubular member moves in a distal direction by force of the coil spring. The force is aligned with centers of resistance of molars in the mouth of the user.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

This invention is related to an orthodontic appliance, specifically a maxillary molar distalization jig, which moves the maxillary molars back and corrects their positions.

### BACKGROUND OF THE INVENTION

Over the past ten years non-extraction treatment and non-compliance therapies have become more popular in correction of Class II malocclusions. Treatment of Class II cases usually requires distal movement of maxillary molars in order to achieve Class I molar and canine relationship. However, if the maxillary molars are not distalized bodily and adequate anchorage is not established to move premolars and canines distally, anchorage will be lost very easily. In the literature, various types of devices were developed for molar distalization. For years headgear was used routinely for distal movement of maxillary molars. However, headgear totally relied on patient cooperation, which could reduce treatment success and increase treatment duration. On the other hand, headgear was rejected by many patients because of aesthetic and social concern.

The difficulties of headgear wear and dependence on patient cooperation stimulated many investigators to develop new intra-oral devices and techniques for distal movement of molars. In 1978 Blechman, in 1988 Gianelly, in 1992 Bondemark used magnets for molar distalization. In 1991, Gianelly and in 1994 Bondemark used super-elastic Ni—Ti coil springs for distal movement of maxillary molars.

In 1992 Hilgers developed the pendulum appliance for distal movement of molar. The application consisted of TMA springs and a button on the palate. The appliance got its popularity in the mid nineties. In 1996 Ghosh and Nanda, in 1997 Byloff and Darendeliler and in 2000 Bussck and McNamara and another study in the same Year, Joseph and Butchart, conducted studies on the pendulum appliance. From the distalization point of view all of the pendulum studies demonstrated that the molar were distalized with the expense of distal tipping. The amount of tipping in all of these pendulum studies varied from 6.07 to 17.7.

Keles and Sayinsu in 2000 developed IBMD for molar distalization. Their distalizing (0.032″×0.032″) TMA spring design was composed of two components which enabled moving the molars bodily. Their results showed that the molars distalized without tipping; however, the expense of bodily distalization was significant anchorage loss.

In conclusion all the newly introduced intraoral distalization appliance which were developed in the last decade of the 20^{th} century eliminated the patient cooperation; such that, distal tipping of molar and anchorage loss are the main concerns of investigators and the orthodontists.

In the past, various U.S. patent have issued in the field of orthodontic application. For example, U.S. Pat. No. 5,785,520, issued on Jul. 28, 1998 to Carano et al., teaches an orthodontic distalizing apparatus. The apparatus includes a supporting framework on a part of the basal gingiva and underlying bony support of the arch of the user's mouth. The device has an anchor for the framework and pusher elements that may be spring loaded. The pusher elements exert a distalizing force in the direction of the longitudinal axis of the arch.

U.S. Pat. No. 6,626,665, issued on Sep. 30, 2003 to the present inventor, discloses a developed maxillary molar distalization appliance. The appliance has first molar and first premolar bands, an acrylic support plate and soldered wires. This device uses an anterior bite plane to disocclude the posterior teeth, enhance the molar distalization and correct the anterior deep bite. The force system of this invention applies consistent force at the level of the center of resistance of the first molars.

The prior art discloses complex and laboratory-intensive appliances for correction of molar positioning. Due to the complicated nature of prior art devices, chair side construction and installation of the orthodontic appliances were not possible or at least very difficult. For example, welding and soldering required that the preparation occur away from the user's mouth and the use of special equipment. Furthermore, the disclosed acrylic material construction was restricted to the laboratory environment. Chemical cure orthodontic acrylic cannot be used directly in the user's mouth because of toxicity of metil metacylate. A user would require impressions to be taken of the user's mouth and a waiting period for return of the hardened acrylic orthodontic appliance from the laboratory, and installations could take multiple visits because adjustments could not always be made chair side.

### BRIEF SUMMARY OF THE INVENTION

For maxillary molar distalization, an improved intraoral appliance was developed. The present invention is an orthodontic appliance comprised of an acrylic support plate with a wide Nance button and an anterior bite plane, a plurality of retaining wires, a plurality of rigid wire rods, a lock, a coil spring, a tubular member and first molar bands. The acrylic support plate has the plurality of retaining wires extending therefrom and is comprised of acrylic material constructed during installation of the support plate. The first premolar teeth of the user are fixedly attached to the plurality of retaining wires with bonding material chair side. The tubular member has a wire extension for insertion to the cleat on the molar band.

Each wire rod has a distal end in a ball stop shape and a mesial end embedded in the acrylic support plate. The lock is axially mounted on each mesial end of each wire rod and is positioned between the acrylic support plate and the axially mounted coil spring. The tubular member having a wire extension is also axially mounted on each wire rod such that the coil spring is positioned between the tubular member and the lock. The first molar bands removably attach to each wire extension of the tubular member by a cleat. The wire rod and tubular member are normally comprised of stainless steel.

The acrylic support plate is mountable in a user's mouth so as to receive dental support from upper front teeth and soft tissue and bony support from palatal gingiva and underlying bone of an upper jaw of the user's mouth. The anterior bite plane prevents contact between upper and lower posterior teeth of the user. More specifically, the dental support can be comprised of eight upper front teeth of the user, palatal sides of six upper anterior teeth, and first premolars of the user, the first premolars being fixedly connected to the retaining wires with bonding material chair side. The opposite ends of the retaining wires and positioned in the acrylic.

When the coil spring is compressed between the acrylic support plate and the tubular member by tightening the lock, the tubular member moves in a distal direction by force of the coil spring. According to the present invention, the force is aligned with centers of resistance of molars in the user's mouth.

The tubular member is removably attached to the first molar bands on a palatal side of the user's mouth such that the wire extension faces a gingival side of the user's mouth. The tubular member has a longitudinal axis oriented parallel to an occlusal surface of molars of the user's mouth and is freely slidably along each wire rod.

### BRIEF DESCRIPTION OF THE SEVERAL VIEWS OF THE DRAWINGS

FIG. 1 is an inner side elevation view, or lateral palatal view, which shows the present invention as attached to a user's mouth.

FIG. 2 is an elevation view, or occlusal view, which shows the present invention as attached to a user's mouth.

FIG. 3 is an exploded perspective view of individual parts of the present invention.

### DETAILED DESCRIPTION OF THE INVENTION

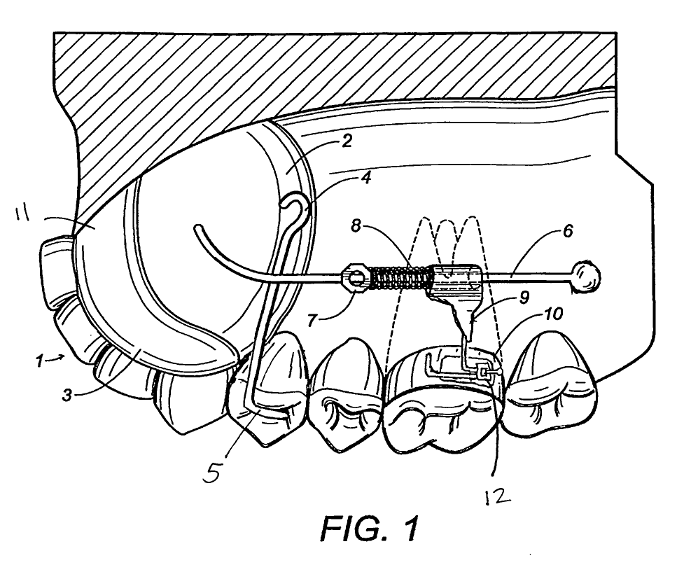

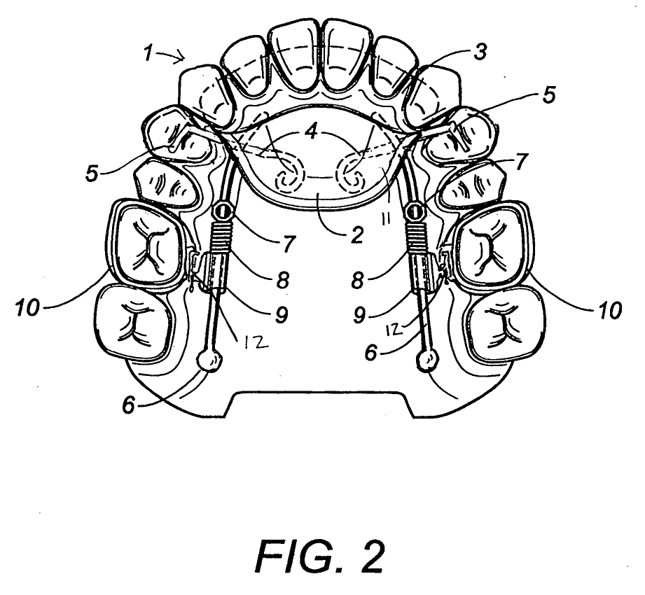

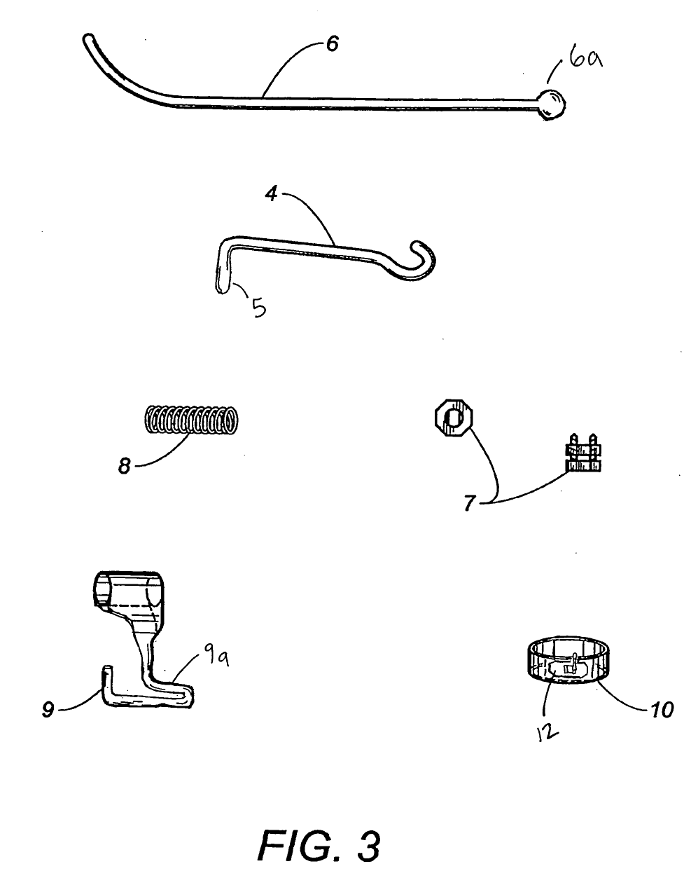

Referring to FIGS. 1-3, the present invention is an orthodontic appliance. FIG. 1 shows a lateral palatal view with the appliance installed in a user's mouth, and FIG. 2 is the occlusal view of the present invention shown in FIG. 1. FIG. 3 shows several individual parts of the orthodontic appliance of the present invention.

As shown in the Figures, the orthodontic appliance 1 of the present invention includes an acrylic support plate 11 with a Nance button 2 and an anterior bite plane 3. The acrylic support plate 11 is comprised of acrylic material constructed during installation of the support plate 11. There is a plurality of retaining wires 4 extending from the acrylic support plate 11. These retaining wires are attached to the first premolar teeth of the user's mouth with bonding material chair side at bonding ends 5. The retaining wires 4 are bonded directly chair side on the chewing surface of the first premolar teeth by respective bonding ends 5, while the opposite ends are embedded into the acrylic of the acrylic support plate 11.

The present invention also includes a plurality of rigid wire rods 6. Each wire rod 6 has a distal end 6a in a ball stop shape and a mesial end embedded in the acrylic support plate 11. There is also a lock 7 and coil spring 8 axially mounted on each wire rod 6. The lock 7 is positioned between the acrylic support plate 11 and the coil spring 8.

As further shown in the Figures, a tubular member 9 has a wire extension 9a and is also axially mounted on each wire rod 6. The coil spring 8 is positioned between the tubular member 9 and the lock 7. A set of first molar bands 10 removably attach to each wire extension 9a of the tubular member 9. The first molar bands 10 have a cleat 12, or more specifically a Trans Palatal Arch (TPA) attachment. Prior to cementation to the first molar teeth of the user, the cleat 12 is welded to each first molar band 10. The attachment of the cleat 12 can be performed well in advance of installation into a user's mouth. The wire rod 6 and tubular member 9 are comprised of stainless steel.

As shown in FIGS. 1 and 2, the acrylic support plate 11 is mountable in a user's mouth so as to receive dental support from upper front teeth and soft tissue and bony support from palatal gingiva and underlying bone of an upper jaw of the user's mouth. The anterior bite plane 3 prevents contact between upper and lower posterior teeth of the user. More specifically, the dental support can be comprised of eight upper front teeth of the user, palatal sides of six upper anterior teeth, and first premolars of the user, the first premolars being fixedly connected to acrylic support plate 111 by the retaining wires 4 by the bonding ends 5.

When the coil spring 8 is compressed between the acrylic support plate 11 and the tubular member 9 by tightening the lock 7, the tubular member 9 moves in a distal direction by force of the coil spring 8. According to the present invention, the force is aligned with centers of resistance of molars in the user's mouth. The first molar teeth are moved in the distal direction because of the attachment to the respective wire extensions 9a.

The tubular member 9 is removably attached to the first molar bands 10 on a palatal side of the user's mouth such that the wire extension 9a faces a gingival side of the user's mouth. The tubular member 9 has a longitudinal axis oriented parallel to an occlusal surface of molars of the user's mouth and is freely slidably along each wire rod 6. The tubular member 9 is adjustable within the mouth of the user such that installation and tension adjustment can be performed chair side and without the need to remove the appliance 1 from the mouth.

On the palatal side shown in FIG. 2, the first molar bands 10 are first molar bands no longer have 0.045 inch diameter tubes soldered as disclosed in the prior art. The present invention allows for the wire extension 9a to removably attach to the molar bands 10 without the need for soldering and special equipment. The installation of the appliance 1 can be accomplished chair side without extreme difficulty or risk to the user. Furthermore, the appliance is adjustable without the need to re-solder once the molar attached to the molar bands 10 have moved.

The first premolar teeth can be attached chair side with bonding material to the retaining wires 4 to a wide acrylic Nance button 2 of the acrylic support plate 11. The Nance button 2 and the anterior bite plane 3 are constructed with acrylic material prepared chair side. Light cure acrylic can be used directly in the user's mouth because light hardens the material, instead of toxic chemicals as in the prior art. This acrylic allows easier installation of the device because of the lack of laboratory intensive materials and equipment. The purpose of creating the anterior bite plane 3 was to disocclude the posterior teeth, enhance the molar distalization and correct the anterior deep bite. As previous disclosed in the prior art, the present invention achieves these benefits in a significantly improved device that has chair side application and adjustment capabilities.

Also on the palatal side view of FIG. 2, stainless steel wire rods 6 are embedded into the acrylic support plate 11 about 5 mm apical to the gingival margin of the first molars. The wire rods 6 pass through the tubular member 9, oriented parallel to the occlusal plane. For molar distalization, the Ni—Ti coil spring 8 can be placed in between the lock 7 on the wire rod 6 and tubular member 9 in full compression. This force system allows applying consistent force at the level of center of resistance of the first molars.

On the palatal side view of FIG. 2, it can be seen that the point of distal force application is carried towards the center of resistance of the maxillary first molar in order to achieve bodily distal movement. Ni—Ti coil springs 8 are used, and distal force was applied to the molars.

The present invention is an improved maxillary molar distalization jig that allows for chair side installation and adjustment of the jig. The user avoids the complicated and laboratory-intensive appliances of the prior art, while achieving the desired molar distalization.

The foregoing disclosure and description of the invention is illustrative and explanatory thereof. Various changes in the details of the illustrated construction or in the steps of the described invention can be made within the scope of the appended claims without departing from the true spirit of the invention. The present invention should only be limited by the following claims and their legal equivalents.

1. An orthodontic appliance for use in a mouth of a user comprising:
an acrylic support plate with a Nance button and an anterior bite plane, said acrylic support plate being comprised of an acrylic material constructed during installation of said acrylic support plate in the mouth;
a plurality of retaining wires extending from said acrylic support plate and being fixedly attached to said acrylic support plate during installation of said acrylic support plate;
a plurality of rigid wire rods in which each wire rod has a distal end in a ball stop shape and a mesial end embedded in said acrylic support plate;
a lock axially mounted on the mesial end of each wire rod;
a coil spring axially mounted on each wire rod, said lock being positioned between said acrylic support plate and said coil spring;
a tubular member having a wire extension and being axially mounted on each wire rod, said coil spring being positioned between said tubular member and said lock; and
a plurality of first molar bands removably attached respectively to each wire extension of said tubular member.

2. The appliance according to claim 1, wherein said acrylic support plate is mountable in the mouth of the user so as to receive dental support from upper front teeth and soft tissue and bony support from palatal gingiva and underlying bone of an upper jaw of the mouth of the user.

3. The appliance according to claim 2, wherein upper and lower posterior teeth of the user have a gap therebetween when said anterior bite plane of said acrylic support plate contacts anterior teeth of the user.

4. The appliance according to claim 2, wherein said dental support is comprised of eight upper front teeth of the user, palatal sides of six upper anterior teeth, and first premolars of the user, said first premolars being fixedly connected to said plurality of retaining wires.

5. The appliance according to claim 2, wherein said coil spring is compressed between said acrylic support plate and said tubular member by tightening said lock, said tubular member being movable in a distal direction by force of said coil spring, said force being aligned with centers of resistance of molars in the mouth of the user.

6. The appliance according to claim 1, wherein the tubular member is removably attached to said first molar bands on a palatal side of the mouth of the user, said tube member being comprised of stainless steel, said wire extension being located towards a gingival side of the mouth of the user; wherein said tubular member has a longitudinal axis oriented parallel to an occlusal surface of molars of the mouth of the user; and wherein said tubular member is freely slidably along each wire rod.

7. The appliance according to claim 1, wherein each wire rod is comprised of heavy stainless steel.

8. The appliance according to claim 1, wherein said coil spring is compressed between said acrylic support plate and said tubular member by tightening said lock, said tubular member being movable in a distal direction by force of said coil spring; and wherein said first molar bands are pushed back from said acrylic support plate.
